(19) United States
(12) Patent Application Publication
(10) Pub. No.: US 2013/0254080 A1
(43) Pub. Date: Sep. 26, 2013

(54) Casual Dynamic Model for Revenue

(71) Applicants: Jerry Z. Shan, Palo Alto, CA (US); Kirill Bogouslavski, San Francisco, CA (US)

(72) Inventors: Jerry Z. Shan, Palo Alto, CA (US); Kirill Bogouslavski, San Francisco, CA (US)

(21) Appl. No.: 13/883,488

(22) PCT Filed: Nov. 27, 2010
(86) PCT No.: PCT/US10/58140

§ 371 Date: May 3, 2013

(51) Int. Cl. G06Q 40/00

(52) U.S. Cl. CPC G06Q 40/10
USPC 705/30

(57) ABSTRACT

Drivers that affect or relate to revenue to be forecast are identified. Each driver is a variable. One or more particular drivers are selected from the drivers, based on an analysis of the lags between the revenue and the drivers as synchronized. A causal dynamic model for the revenue is constructed using the particular drivers selected.

### BACKGROUND

A business entity like a corporation focuses on revenue as a barometer as to how well the business entity is performing. Gross revenue is the income that a business entity receives from its normal business activities, such as the sale of goods and services. Net revenue can be the gross revenue minus the expenses that the business entity incurred in performing its normal business activities, including salaries, capital expenses, and potentially taxes.

### BRIEF DESCRIPTION OF THE DRAWINGS

FIGS. 1A and 1B are flowcharts of a method for constructing a causal dynamic model, according to an example of the disclosure.

FIG. 2A is a graph of example historical revenue, and FIGS. 2B, 2C, 2D, 2E, 2F, 2G, 2H and 2I are graphs of example drivers.

FIG. 3 is a graph of the revenue and the drivers of FIGS. 2A-2I after normalization, according to an example of the disclosure.

FIGS. 4A and 46 are graphs of cross-correlation between the revenue of FIG. 2A and the drivers of FIGS. 2D and 2G, respectively, according to examples of the disclosure.

FIG. 5 is a graph of the revenue of FIG. 2A and the drivers of FIGS. 2C, 2G, and 2I.

FIG. 6 is a graph of FIG. 5 after the drivers of FIGS. 2C, 2G, and 2I have been synchronized with the revenue of FIG. 2A in accordance with their lagging effects on the revenue.

FIG. 7 is a diagram of the results of performing an analysis of variance (ANOVA) on the drivers of FIGS. 2C, 2G, and 2I, according to an example of the disclosure.

FIG. 8 is a diagram of a system, according to an example of the disclosure.

### DETAILED DESCRIPTION

As noted in the background section, a business entity focuses on revenue as a barometer as to how well the business entity is performing. It can be desirable for the business entity to forecast revenue, such as gross revenue or net revenue. However, existing approaches to forecasting revenue are often flawed, insofar as they are based on faulty and/or simplistic assumptions that do not reflect the complexities of the business entity's operation.

Disclosed herein are approaches for constructing a causal dynamic model for revenue. The causal dynamic model is constructed using drivers. A driver is a variable that affects or relates to the revenue to be forecast. Generally, drivers are identified, and cross-correlation is performed for each driver to identify lag between the revenue and the driver. The revenue and at least some drivers are synchronized based on this lag, and particular drivers are selected based on an analysis of the lags between the drivers and the revenue. The causal dynamic model is then constructed for the revenue using the particular drivers selected.

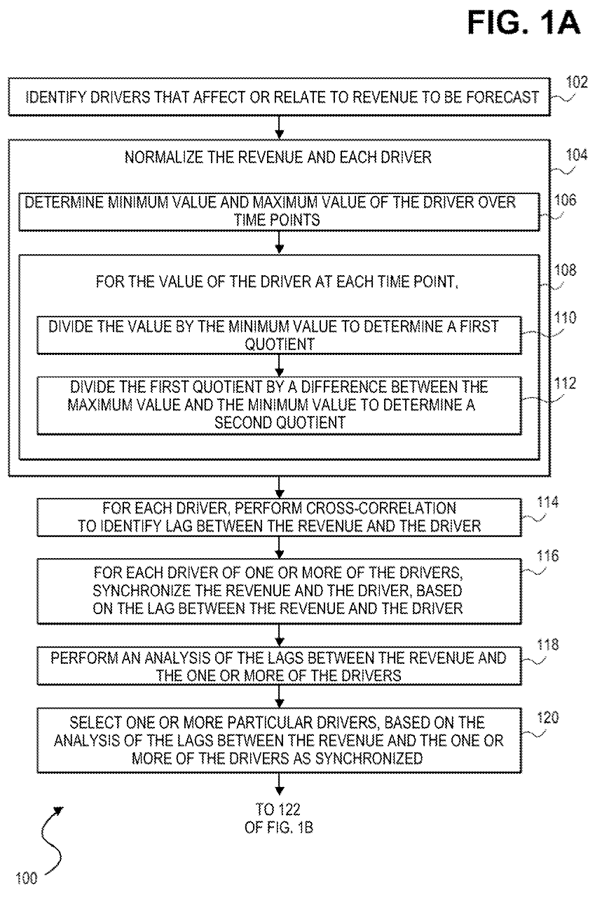

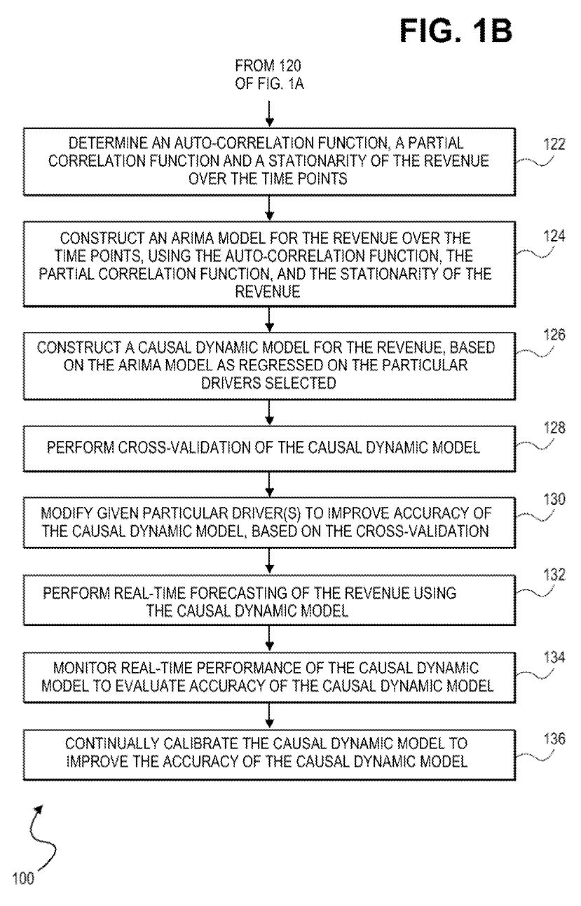

More specifically, FIGS. 1A and 1B show a method 100 for constructing a causal dynamic model, according to an example of the disclosure. At least some parts of the method 100 can be performed by a processor, such as a processor of a computing device like a desktop computer or a laptop computer. For instance, at least some parts of the method 100 may be implemented as a computer program stored on a non-transitory computer-readable data storage medium. Execution of the computer program by the processor thus results in performance of these parts of the method 100.

Referring first to FIG. 1A, drivers are identified that affect or relate to the revenue to be forecast (102). The drivers identified in part 102 are candidate drivers that are likely to be leading indicators for the revenue. The identified drivers are subsequently culled in a subsequent part of the method 100, however. A driver is generally a variable that has a value for each of a number of time points. For these same time points, the revenue is also known. As such, the causal dynamic model ultimately is constructed based on historical data.

The drivers can be identified in part 102 by business analysis, modelers, and managers of the business entity in question. Each driver may have a direct causal effect relationship to the revenue, or each driver may be conceptually correlated to revenue on a lagging or leading basis, either negatively or positively. A driver may be specific to the business entity. For example, a business entity may use a unit of production to generate the product that it sells. There may be different types of such units of production. The number of each type of unit of production may be considered a driver.

A driver may alternatively be specific to the industry in which the business entity operates. For example, the number of products sold by all the business entities within the industry may be a driver. A driver may alternatively be a national-wide driver or an international-wide driver. For example, a national-wide driver may be the gross domestic product of a country in which the business entity operates. As another example, an international-wide driver may be the percentage increase or decreases in growth of the global economy.

FIG. 2A is a graph of example historical revenue, whereas FIGS. 2B-2I are graphs of example drivers, which are referred to as the drivers 1, 2, 3, 4, 5, 6, 7, and 8, respectively. The revenue in FIG. 2A has a currency value, such as United States dollars, along the y-axis for each of a number of time points along the x-axis. Likewise, each example driver has a value in a given type of unit along the y-axis over time points along the x-axis. The units of the example drivers can differ from one another.

Referring back to FIG. 1A, each driver may be normalized (104). Different drivers have different scales along their y-axes. As such, the drivers—as well as the revenue—can be normalized to the same scale so that they can be directly compared. The drivers and the revenue can be normalized as follows, where the discussion is particularly made in relation to a given driver as representative of the revenue and each driver.

The minimum value and the maximum value of the driver along the y-axis over the time points along the x-axis are determined (106). For the value of the driver along the y-axis at each time point along the x-axis, the following is performed (108). The value at the time point in question is divided by the minimum value to determine a first quotient (110). The first quotient is divided by the difference between the maximum value and the minimum value of the driver to determine a second quotient (112). The second quotient is thus the normalized value for the driver at the time point in question.

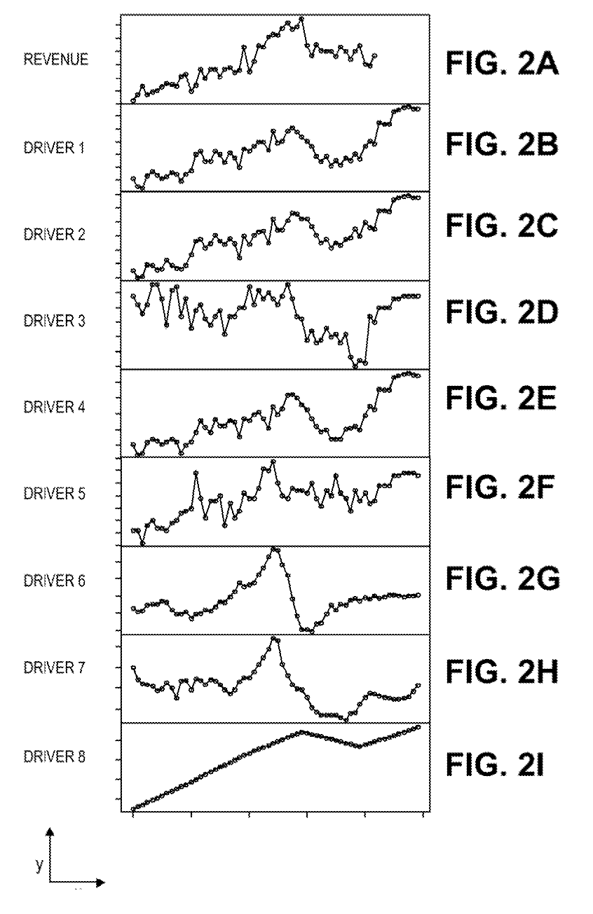

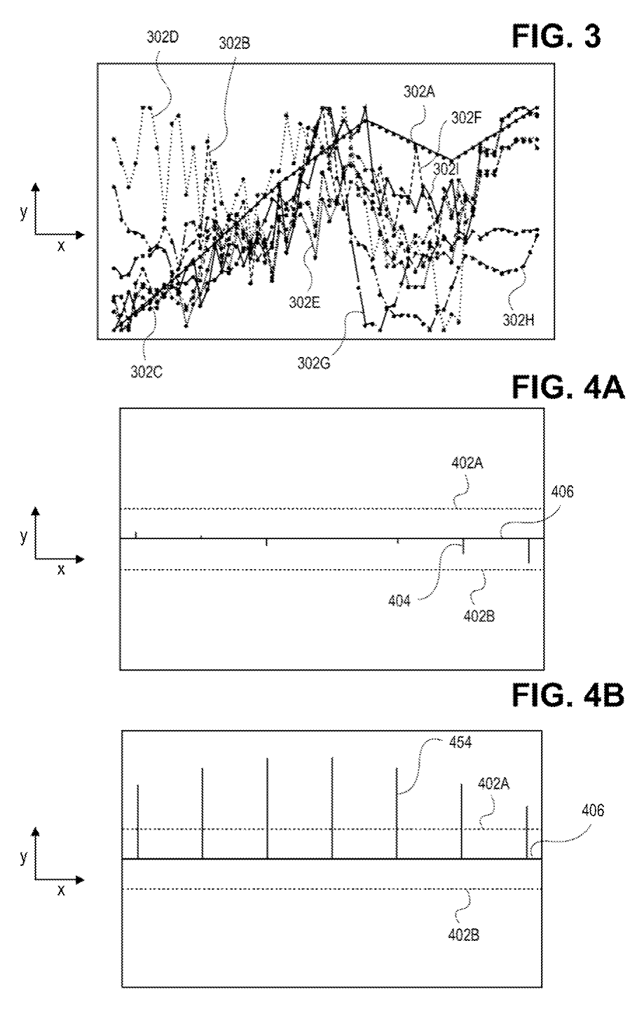

FIG. 3 is a graph of the revenue and the example drivers of FIGS. 2A-2I after normalization. The line 302A corresponds to the revenue of FIG. 2A. The lines 302B, 302C, 302D, 302E, 302F, 302G, 302H, and 302I correspond to the example drivers of FIGS. 2B-2I, respectively. The y-axis of FIG. 3 for the revenue and the driver denotes normalized values. The x-axis of FIG. 3 denotes time points.

Referring back to FIG. 1A, cross-correlation is performed to identify lag between the revenue and each driver (114). Lag is determined with respect to the revenue. For instance, if a driver is a leading indicator of the revenue, then the revenue lags this driver. Such a driver may be selected as a driver to use in constructing the causal dynamic model since the driver may forecast the revenue. By comparison, if a driver is a lagging indicator of the revenue, then the revenue leads this driver; that is, the revenue negatively lags the driver. Such a driver may not be selected to use in constructing the causal dynamic model since the driver may not forecast the revenue.

Cross-correlation between the revenue and a driver may be performed by determining a cross auto-correlation function of the revenue based on the driver. If the lagged cross-correlation between the revenue and the driver at each time point is statistically insignificant, then the driver is uncorrelated to the revenue over time. By comparison, if one or more lagged cross-correlations between the revenue and the driver at corresponding time points are statistically significant, then the driver has a statistically significant leading effect on the revenue if the lagged cross-correlations on the revenue by the driver are positive.

FIGS. 4A and 4B are graphs of cross-correlation between the revenue of FIG. 2A and the drivers of FIGS. 2D and 2G, respectively. The x-axes of FIGS. 4A and 4B denote lag in units of time, whereas the y-axes of FIGS. 4A and 4B denote cross-correlation, where line 406 indicates no correlation. Lines 402A and 402B, collectively referred to as the lines 402, denote predetermined significant bounds of cross-correlation. That is, cross-correlation between the lines 402 is statistically insignificant, whereas cross-correlation outside the lines 402 is statistically significant.

In FIG. 4A, there is no statistically significant cross-correlation between the driver of FIG. 2D and the revenue of FIG. 2A. This is because each vertical line within FIG. 4A, such as the line 404, falls between the lines 402. In FIG. 48, there is statistically significant cross-correlation between the driver of FIG. 2G and the revenue of FIG. 2A. This is because a number of vertical lines within FIG. 48, such as the line 454, falls outside the lines 402. Furthermore, the vertical lines such as the line 454 are positive, which means that the driver of FIG. 2G is a leading indicator of the revenue of FIG. 2A.

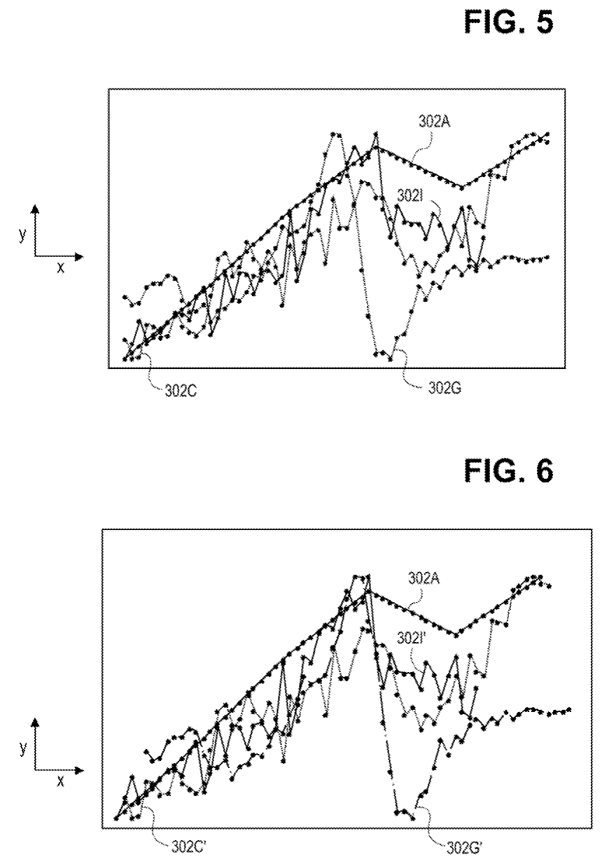

FIG. 5 is a graph of the revenue of FIG. 2A and the example drivers of FIGS. 2C, 2G, and 2I. The graph of FIG. 5 is the graph of FIG. 3 with just the lines 302A, 302C, 302G, and 302I. The line 302A corresponds to the revenue of FIG. 2A. The lines 302C, 302G, and 302I correspond to the example drivers of FIGS. 2C, 2G, and 2I, respectively. The y-axis of FIG. 5 denotes normalized values, whereas the x-axis of FIG. 5 denotes time points. The example drivers of FIGS. 2C, 2G, and 2I are the drivers that have statistically significant cross-correlation with the revenue of FIG. 2A.

Referring back to FIG. 1A, the revenue is synchronized with each driver of one or more of the drivers, based on the lag between the revenue and each of the one or more of the drivers (116). The one or more of the drivers in relation to which the revenue is synchronized may be the drivers that have statistically significant cross-correlation, as determined in part 114. While each of these drivers can have a different correlation with revenue, the revenue may lag each driver differently. That is, each driver may lead the revenue at a different time period. As such, synchronization is performed to synchronize each such driver to the revenue based on the most statistically significant correlation the revenue has with each driver.

FIG. 6 is a graph of the revenue of FIG. 2A and the example drivers of FIGS. 2C, 2G, and 2I, where these drivers have been synchronized with the revenue in accordance with their lagging effects on the revenue. The graph of FIG. 6 is the graph of FIG. 5, where the lines 302C′, 302G′, and 302I′ of FIG. 6 are the lines 302C, 302G, and 302I, respectively, of FIG. 5 after synchronization with the line 302A corresponding to the revenue of FIG. 2A. The lines 302C′, 302G′, and 302I′ again correspond to the example drivers of FIGS. 2C, 2G, and 2I, respectively. As before, the y-axis of FIG. 6 denotes normalized values, and the x-axis of FIG. 6 denotes time points.

Referring back to FIG. 1A, an analysis is performed on the lags between the revenue and the one or more of the drivers (118). The analysis that is performed can be an analysis of variance (ANOVA) on the one or more of the drivers. One or more particular drivers are then selected based on this analysis (120). The particular drivers are the drivers on which basis the causal dynamic model for the revenue is constructed later in the detailed description.

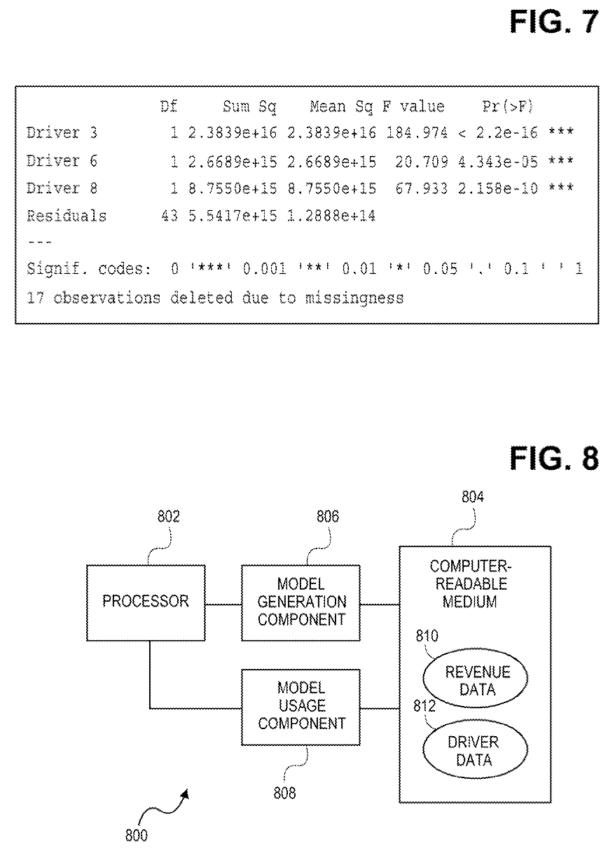

FIG. 7 shows the results of an example ANOVA of the drivers of FIGS. 2C, 2G, and 2I, which are the drivers 2C, 2G, and 2I. The results of the ANOVA include Df, which signifies the degrees of freedom in performing the analysis; Sum Sq, which signifies a sum of a square of the residuals in performing the analysis; and, Mean Sq, which signifies a mean of this square. The residuals of the ANOVA are the differences between the observed revenue values and the values fitted from the underlying statistical models used in the ANOVA. The results of the ANOVA further include an F value, which signifies the result of an F-test that is performed as part of the ANOVA; and, Pr(>F), which signifies the probability of observing a value as large as F value, and which also is referred to as the P value. The F-test is a statistical significance test that has an F-distribution, and is used when comparing statistical models that have been fit to a data set, to identify the best-fitting model. An F-distribution is a continuous probability distribution, and is also known as Snedecor's F distribution or the Fisher-Snedecor distribution

The significance of the results of the ANOVA is indicated as 0, 0.001, 0.01, 0.05, 0.1, or 1 via three asterisks, two asterisks, one asterisk, or no asterisks, respectively, in FIG. 7. In general, the more asterisks, the higher the statistical significance of a driver in forecasting the revenue. As such, in the example of FIG. 7, the drivers 3, 6, and 8 each is statistically significant in forecasting the revenue. Therefore, each of the drivers 3, 6, and 8 is selected as a particular driver on which basis the causal dynamic model for the revenue is subsequently constructed.

Referring next to FIG. 1B, an auto-correlation function, a partial-correlation function, and a stationarity of the revenue are determined over the time points (122). Stationarity is defined as a quality of a time series process, such as revenue, in which statistical parameters of the process, like mean and standard deviation, do not change with time. Either the stationarity can be directly determined, or the number of differencing steps to arrive at the stationarity can be determined. The auto-correlation function, the partial-correlation function, and the stationarity yield periods of time (i.e., one or more ranges of time points) in which the revenue is auto-correlated, correlated with a white noise process (i.e., a random disturbance), and has stationarity, respectively. An autoregressive integrated moving average (ARIMA) model is constructed based on these time periods (124).

The causal dynamic model for the revenue is constructed, based on the ARIMA model constructed in part 122, as regressed on the particular drivers selected in part 120 (126). That is, the causal dynamic model is constructed by regressing the ARIMA model constructed in part 122 over the particular drivers selected in part 120. The model is causal in that it forecasts revenue using the selected drivers. Furthermore, the model is dynamic in that it is based on underlying changing drivers, specifically the particular drivers selected in part 120. As such, the causal dynamic model is able to dynamically forecast the revenue based on the values of the particular drivers selected in part 120 over various time points.

The causal dynamic model can be cross-validated (128). Cross-validation is a statistical technique that is used to determine the accuracy of the causal dynamic model. In particular, the causal dynamic model may be generated using one or more portions of the historical data that is available for the revenue and the particular drivers, and then tested against one or more other portions of the historical data to determine how well the model predicts these other portions of the historical data. Cross-validation of the causal dynamic model therefore yields the accuracy of the model, which may be expressed as mean absolute percentage error (MAPE), mean squared error (MSE), and bias. Based on these results, the causal dynamic model may be modified in various ways to improve the accuracy of the model (130). For instance, the particular drivers can be reselected, and the leading times of these drivers and parameters of the causal dynamic model may be modified slightly so that MAPE, MSE, and/or bias is improved.

Once the causal dynamic model has been constructed, and cross-validated and modified as desired, real-time forecasting of the revenue is performed using the model (132). Specifically, as data for the particular drivers selected in part 120 becomes available, the data is input into the causal dynamic model to forecast the revenue. It has been found that the causal dynamic model outputs forecast revenue that is more accurate than revenue forecast by existing techniques.

The real-time performance of the causal dynamic model can be monitored as data regarding actual revenue is obtained (134). For instance, based on the data for the particular drivers selected in part 120 becoming available, the causal dynamic model may forecast a given amount of revenue for a future fiscal quarter. Once this fiscal quarter has arrived, the actual revenue can be compared to the revenue forecast by the causal dynamic model, to continually evaluate and assess the accuracy of the model. As such, the causal dynamic model can be continually calibrated to improve the accuracy of the model (136). The calibration in part 136 can involve the same type of modifications to the causal dynamic model that can be made in part 130.

FIG. 8 shows a system 800. according to an example of the disclosure. The system 800 may be implemented as one or more computing devices, such as desktop computers and laptop computers. The system 800 includes a processor 802, a non-transitory computer-readable data storage medium 804, a model generation component 806, and a model usage component 808.

The computer-readable data storage medium 804 stores revenue data 810 and driver data 812. The revenue data 810 is historical data of revenue for each of a number of time points. The driver data 812 is historical data of each of a number of drivers for each of a number of time points.

The components 806 and 808 can each be one or more computer programs that are executable by the processor 802. These computer programs may be stored on the computer-readable data storage medium 804, or another computer-readable data storage medium. The model generation component 806 is to generate a causal dynamic model for revenue based on the revenue data 810 and the driver data 812, in accordance with the method 100 of FIGS. 1A and 1B. The model usage component 808 is to use the causal dynamic model to forecast revenue, in accordance with part 132 of the method 100.

1. A method comprising:
identifying a plurality of drivers that affect or relate to revenue to be forecast, each driver being as variable;
selecting one or more particular drivers from the drivers, based on an analysis of lags between the revenue and the drivers as synchronized; and,
constructing, by the processor, a casual dynamic model for the revenue, using the particular drivers selected.

2. The method of claim 1, further comprising, after identifying the plurality of drivers;
for each driver, performing cross-correlation by a processor to identify the lag between the revenue and the driver; and,
for each driver of one or more of the drivers, synchronizing the revenue and the driver by the processor, based on the lag between the revenue and the driver.

3. The method of claim 1, further comprising normalizing the revenue and each driver, by the processor.

4. The method of claim 3, wherein normalizing each driver comprises:
determining a minimum value of the driver over a plurality of time points;
determining a maximum value of the driver of the time points;
for a value of the driver at each time point,
dividing the value by the minimum value to determine as first quotient;
dividing the first quotient by a difference between the maximum value and the minimum value to determine a second quotient, the second quotient being as normalized value for the driver at the time point.

5. The method or claim 1, further comprising, before selecting the particular drivers:
performing the analysis of the lags between the revenue and the drivers,
wherein the analysis is an analysis of variance (ANOVA).

6. The method of claim 1, further comprising, after selecting the particular drivers:
constructing, by the processor, an autoregressive integrated moving average (ARIMA) model for the revenue over a plurality of time points,
wherein the causal dynamic model for the revenue is constructed further using the ARIMA model.

7. The method of claim 6, further comprising, prior to constructing the ARIMA model:
determining, by the processor, an auto-correlation function for the revenue over the time points;
determining, by the processor, a partial auto-correlation function for the revenue over the time points; and,
determining, by the processor, a stationarity of the revenue over the time points,
wherein the ARIMA model is constructed using the auto-correlation function, the partial auto-correlation function, and the stationarity.

8. The method of claim 6, wherein the causal dynamic model for the revenue is constructed based cm the ARIMA model as regressed on the particular drivers selected.

9. The method of claim 1, further comprising, after constructing the causal dynamic model:
performing cross-validation of the causal dynamic model, by the processor; and,
modifying a given particular driver of the particular drivers to improve accuracy of the causal dynamic model, based cm the cross-validation of the causal dynamic model.

10. The method of claim 1, further comprising:
performing, by the processor, real-time forecasting of the revenue using the causal dynamic model.

11. The method of claim 10, further comprising:
monitoring, by the processor, real-time performance of the causal dynamic model based on actual revenue as compared to forecast revenue to evaluate accuracy of the causal dynamic model; and,
calibrating the causal dynamic model, by the processor, based on the accuracy of the causal dynamic model to improve the accuracy of the causal dynamic model.

12. A non-transitory computer-readable data storage medium to store a computer program, execution of the computer program by a processor causing a method to be performed, the method comprising:
performing real-time forecasting of revenue using a causal dynamic model for the revenue based on one or more particular drivers that affect or relate to revenue,
wherein the causal dynamic model is constructed by:
identifying a plurality of drivers that affect or relate to revenue to be forecast, each driver being a variable, each particular driver being one of the drivers identified;
for each driver, performing cross-correlation to identify lag between the revenue and the driver;
for each driver of one or more of the drivers, synchronizing the revenue and the driver, based on the lag between the revenue and the driver;
selecting the particular drivers from the one or more of the drivers, based on an analysis of the lags between the revenue and the one or more of the drivers as synchronized; and,
constructing the causal dynamic model for the revenue, using the particular drivers selected.

13. The non-transitory computer-readable data storage medium of claim 12, wherein the causal dynamic model is farther constructed by:
prior to performing the cross-correlation for each driver, normalizing each driver;
before selecting the particular drivers, performing the analysis of the lags between the revenue and the one or more of the drivers, the analysis being an analysis of variance (ANOVA); and,
after selecting the particular drivers, constructing an autoregressive integrated moving average (ARIM) model for the revenue over a plurality of time points, such that the causal dynamic model for the revenue is constructed further using the ARIMA model.

14. A system comprising:
a processor;
a computer-readable data storage medium to store revenue over a plurality of time points, and a value of each of a plurality of drivers for each time point; and,
a model generation component executable by the processor to:
for each driver, perform cross-correlation to identify lag between the revenue and the driver;
for each driver of one or more of the drivers, synchronize the revenue and the driver, based on the lag between the revenue and the driver;
select one or more particular drivers from the one or more of the drivers, based on an analysis of the lags between the revenue and the one or more of the drivers as synchronized; and,
construct a causal dynamic model for the revenue, using the particular drivers selected.

15. The system of claim 14, wherein the model generation component is further to:
before selecting the particular drivers, perform the analysis of the lags between the revenue and the one or more of the drivers, the analysis being an analysis of variance (ANOVA); and
after selecting the particular drivers, construct an autoregressive integrated moving average (ARIM) model for the revenue over the time points, such that the causal dynamic model for the revenue is constructed further using the ARIMA model.
